(19) United States
(12) Patent Application Publication
(10) Pub. No.: US 2026/0254861 A1
(43) Pub. Date: Aug. 27, 2026

(54) ENABLING NETWORK SLICE FEATURES IN INTERNET PROTOCOL MULTIMEDIA SUBSYSTEM (IMS)

(71) Applicant: T-MOBILE INNOVATIONS LLC, Overland Park, KS (US)

(72) Inventor: A. Karl Corona, Maple Valley, WA (US)

(21) Appl. No.: 19/061,394

(22) Filed: Feb. 24, 2025

(51) Int. Cl. H04L 65/1073; H04L 65/1016; H04W 48/18

(52) U.S. Cl. CPC H04L 65/1073; H04L 65/1016; H04W 48/18

(57) ABSTRACT

Various embodiments include a system that comprises Call Session Control Function (CSCF) circuitry in a communication network. The CSCF circuitry receives an Internet Protocol Multimedia Subsystem (IMS) registration request for a user device. The CSCF circuitry queries a Network Slice Selection Function (NSSF) for a network slice Identifier (ID) for a network slice that the user device is assigned to in response to reception of the IMS registration request. The CSCF circuitry determines a slice feature based on the slice ID. The CSCF circuitry enables the slice feature for IMS service to the user device.

### TECHNICAL FIELD

Various embodiments of the present technology relate to Internet Protocol Multimedia Subsystem (IMS), and more specifically, to enabling network slice features in IMS.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Wireless communication networks implement network slicing to serve wireless user devices. A network slice is a type of network partition that groups a set of RAN and core network resources that have capabilities to provide one or more service types. Network slices may be configured to provide low-latency services, media streaming services, Internet-of-Things (IoT) services, and the like. Network slices comprise features like maximum allowed latency, Guaranteed Bit Rate (GBR), Quality-of-Service (QoS) level, dedicated bandwidth, priority scheduling, and/or other features to support the one or more service types. Exemplary slice types include Ultra-Reliable Low Latency Communication (URLLC), Enhanced Mobile Broadband (eMBB), Massive Machine Type Communications (mMTC), Vehicle-to-Everything (V2X), Fixed Wireless Access (FWA), and private. By implementing network slicing, wireless communication networks optimize the computing and radio resources for specific service types thereby enhancing the overall user experience.

An Internet Protocol Multimedia Subsystem (IMS) delivers Internet Protocol (IP) multimedia services like voice calling and video conferencing to wireless user devices. The IMS distributes IP addresses to the wireless user devices to facilitate communications between the wireless user devices. The IMS interfaces with wireless network cores to exchange Session Initiation Protocol (SIP) messages with the wireless user devices to communicate with the wireless user devices. The IMS comprises network functions and network elements like Call State Control Function (CSCF), Telephony Application Server (TAS), and Short Message Service Application Server (SMS AS). IMS is typically unaware of the network slices and slice requirements of the user devices.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for Internet Protocol Multimedia Subsystem (IMS). Some embodiments comprise a method. The method comprises receiving, by a Call Session Control Function (CSCF) in a communication network, an Internet Protocol Multimedia Subsystem (IMS) registration request for a user device. The method further comprises in response to receiving the IMS registration request, querying, by the CSCF, a Network Slice Selection Function (NSSF) for a network slice Identifier (ID) for a network slice that the user device is assigned to. The method further comprises determining, by the CSCF, a slice feature based on the slice ID. The method further comprises enabling, by the CSCF, the slice feature for IMS service to the user device.

Some embodiments comprise a system. The system comprises CSCF circuitry in a communication network. The CSCF circuitry receives an IMS registration request for a user device. The CSCF circuitry queries an NSSF for a network slice ID for a network slice that the user device is assigned to in response to reception of the IMS registration request. The CSCF circuitry determines a slice feature based on the slice ID. The CSCF circuitry enables the slice feature for IMS service to the user device.

Some embodiments comprise one or more non-transitory computer readable storage media having program instructions stored thereon. When executed by a computing system, the program instructions direct the computing system to perform operations. The operations comprise receiving an IMS registration request for a user device in a communication network. The operations further comprise, in response to receiving the IMS registration request, querying a NSSF for a network slice ID for a network slice that the user device is assigned to. The operations further comprise determining a slice feature based on the slice ID. The operations further comprise enabling the slice feature for IMS service to the user device.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a communication network to enable network slice features in Internet Protocol Multimedia Subsystem (IMS).

FIG. 2 illustrates an exemplary operation of the communication network to enable network slice features in IMS.

FIG. 3 illustrates another exemplary operation of the communication network to enable network slice features in IMS.

FIG. 4 illustrates an example of a Fifth Generation (5G) communication network to enable network slice features in IMS.

FIG. 5 illustrates network functions in the 5G communication network that enables network slice features in IMS.

FIG. 6 illustrates an example of a 5G data center and IMS data center in the 5G communication network that enables network slice features in IMS.

FIG. 7 further illustrates the 5G data center and the IMS data center in the 5G communication network that enables network slice features in IMS.

FIG. 8 illustrates an exemplary operation of the 5G communication network to enable network slice features in IMS.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

A network slice is a type of network partition that groups a set of Radio Access Network (RAN) and core network resources that have capabilities to provide one or more service types. When user devices attach to the communication network over a wireless access node (e.g., a gNodeB), the user device may be assigned to a network slice based on the device's subscription on the network, the device's capabilities, the device's session requirements, and device slice requests. Typically, user devices are assigned to network slices that the user devices are authorized to use and that have capabilities that align with the capabilities and session requirements of the user devices. Each network slice comprises a suite of network slice features like maximum allowed latency, Guaranteed Bit Rate (GBR), priority Quality-of-Service (QoS), dedicated bandwidth, priority scheduling, and/or other features to support service on the network slice. For example, an Ultra-Reliable Low-Latency Communications (URLLC) slice may comprise a maximum allowed latency slice feature to ensure user device communications on the slice are within an operator defined latency range.

Internet Protocol Multimedia Subsystem (IMS) provides multimedia services like voice calling and video calling to user devices. IMS operates by assigning Internet Protocol (IP) addresses to user devices and routing multimedia requests from calling user devices to called user devices based on the IP addresses to set up the requested multimedia sessions. To receive IMS services, a user device first registers with the IMS. The IMS interfaces with the core network of the user device's home communication network to authenticate the user device. Upon successful authentication, the IMS registers the user device for IMS service. Conventional communication networks do not extend network slicing to IMS. The IMS functions like Call Session Control Function (CSCF) lack standardized interfaces to slice aware core network functions like Network Slice Selection Function (NSSF). As such, IMS is typically unable to tailor IMS service to user devices based on the network slices of the user device which degrades the overall user experience.

To overcome the above-described problems in conventional wireless communication networks, various embodiments of the present technology relate to enabling network slice features in IMS. In some examples, an IMS CSCF receives a registration request from a wireless user device. In response, the CSCF queries an NSSF in the user device's communication network to determine the slice ID of the wireless network slice that the user device is assigned to. For example, the CSCF and the NSSF may comprise a Fifth Generation Core (5GC) Service Based Interface (SBI) link that communicatively coupled the IMS function with the 5GC network function. The CSCF selects a network slice feature for the user device based on the slice ID received from the NSSF. The CSCF enables the selected network slice feature for IMS services to the wireless user device. By communicatively coupling the CSCF and the NSSF, IMS becomes slice aware which allows IMS to tailor IMS service to the user device based on the network slice of the user device. This improves the overall user experience. Now referring to the Figures.

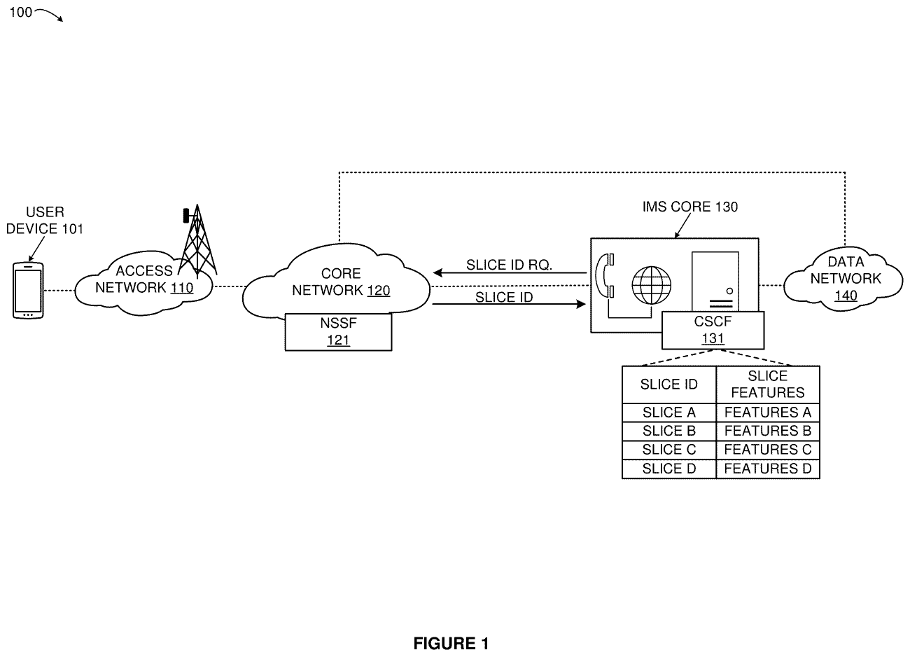

FIG. 1 illustrates communication network 100 to enable network slice features in IMS. Communication network 100 provides services like media-streaming, media-broadcasting, internet-access, voice/video calling, text messaging, online gaming, social media, machine communications, remote device control, and/or some other wireless communications product. Communication network 100 comprises user device 101, access network 110 which is an example of a RAN, core network 120, IMS core 130, and data network 140. Core network 120 comprises NSSF 121. IMS core 130 comprises CSCF 131. CSCF 131 hosts a data structure that correlates slice IDs for network slices A-D to slice features A-D. In other examples, communication network 100 may comprise additional or different elements than those illustrated in FIG. 1.

Various examples of network operation and configuration are described herein. In some examples, user device 101 attaches to core network 120 over access network 110 and registers for wireless data service. Core network 120 selects one or more network slices for user device 101 based on user device 101's subscription on communication network 100. For example, a controller in core network 120 (e.g., an Access and Mobility Management Function (AMF)), may interface with a network data system that stores a subscriber profile and assign user device 101 to a network slice(s) based on service attributes stored in user device 101's subscriber profile. Core network 120 notifies user device 101 of the successful registration and user device 101 begins its session(s) on communication network 100 over the selected network slice(s).

Once registered with core network 120, user device 101 transfers an IMS registration request to IMS core 130 over access network 110 and core network 120. CSCF 131 in IMS core 130 receives the IMS registration request. In response, CSCF 131 queries NSSF 121 in core network 120 to determine the slice ID(s) of user device 101's network slice(s). In this example, it is assumed user device 101 is assigned to a single network slice, however in other examples, user device 101 may be assigned to multiple network slices. NSSF 121 determines the slice ID of the network slice that user device 101 is assigned to and indicates the slice ID to CSCF 131. For example, CSCF 131 may transfer a slice ID request that indicates a subscriber ID for user device 101 like International Mobile Subscriber Identifier (IMSI) to NSSF 121 over a Service Based Interface (SBI) link between CSCF 131 and NSSF 121. NSSF 121 may receive the request and determine the slice ID for user device 101 based on the subscriber ID included in the request. CSCF 131 selects one or more network slice features to enable in IMS core 130 and/or core network 120 for user device 101 based on the slice ID. Exemplary slice features include control plane signaling encryption, user plane data encryption, codec type restriction, priority IMS service, IMS function selection, and the like. For example, CSCF 131 may input the slice ID into the data structure illustrated in FIG. 1 and the data structure may return an output to CSCF 131 that includes one or more slice features.

CSCF 131 enables the selected network slice feature(s) for user device 101 and registers user device 101 for IMS service. For example, if the selected slice feature comprises control plane signaling encryption, CSCF 131 may encrypt control plane signaling between user device 101 and CSCF 131 during the IMS registration process. CSCF 131 indicates the successful IMS registration to user device 101. User device 101 transfers a multimedia session request (e.g., a voice/video call, text message, etc.) to CSCF 131 over access network 110 and core network 120. CSCF 131 determines the message destination (e.g., another user device) for the request and routes the request to the message destination over data network 140. CSCF 131 receives a response from the message destination accepting the session request and indicates the acceptance to user device 101. CSCF 131 interfaces with network functions in core network 120 to establish an end-to-end connection between user device 101 and the message destination. User device 101 exchanges multimedia data (e.g., voice data) with the message destination over the end-to-end connection that traverses access network 110, core network 120, and data network 140. CSCF 131 monitors the multimedia session to enforce the selected network slice feature(s). For example, if the network slice feature comprises user plane data encryption, CSCF 131 may interface with a network function (e.g., a Policy Control Function (PCF) in core network 120 to enforce user plane data encryption between user device 101 and the message destination for the duration of the multimedia session.

Advantageously, communication network 100 effectively and efficiently communicatively couples the CSCF and the NSSF. This coupling makes the CSCF aware of the user device's network slice(s) and allows CSCF to enable slice features thereby tailoring IMS service to the user device based on the network slice of the user device. This improves the overall user experience.

User device 101 may comprise a phone, computer, vehicle, drone, robot, sensor, or another type of data appliances with wireless and/or wireline communication circuitry. User device 101 and access network 110 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Access network 110 may comprise a tower (e.g., to mount a radio at elevation), another type of mounting structure (e.g., a building), or no mounting structure at all. Access network 110 may comprise a Sixth Generation (6G) Radio Access Network (RAN) node, Fifth Generation (5G) RAN node, LTE RAN node, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Although access network 110 is illustrated as comprising a terrestrial access network, in some examples access network 110 may comprise a non-terrestrial (e.g., satellite based) access network. Access network 110 exchanges network signaling and user data with network functions clustered together into core network 120. Access network 110 is connected to core network 120 over one or more backhaul data links. Access network 110 and core network 120 may communicate via edge networks like internet backbone providers, edge computing systems, or another type of edge system to provide the backhaul data and signaling links between access network 110 and core network 120.

Access network 110 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 120. The CUs handle higher wireless network layers like the Radio Resource Control (RRC), Service Data Adaption Protocol (SDAP), and Packet Data Convergence Protocol (PDCP). The CUs are coupled to network functions in core network 120. Alternatively, access network 110 may comprise RUs and Baseband Units (BBUs). The BBUs are usually nearby network computers and handle network layers like RRC, SDAP, PDCP, RLC, MAC, and PHY. The BBUs are coupled to network functions in core network 120.

Core network 120 and IMS core 130 are representative of computing systems that provide wireless multimedia and data services to user device 101 over access network 110. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access network 110, core network 120, IMS core 130, and data network 140 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocol. The computing systems of core network 120 store and execute the network functions/entities to form a control plane and a user plane. Exemplary control plane network functions include AMF, Session Management Function (SMF), PCF, NSSF, Unified Data Management (UDM), Network Repository Function (NRF), Home Subscriber Server (HSS), and the like. Exemplary user plane network functions include User Plane Function (UPF) and the like.

Network slices are representative of collections of network elements (e.g., UPFs, control plane network functions, access nodes, etc.) with capabilities to support different service types over access network 110. For example, a first network slice may comprise low-latency capabilities to support low-latency data sessions while another network slice may comprise high-uplink bandwidth capabilities to support media broadcasting sessions. Exemplary network slice types include Enhanced Mobile Broadband (eMBB), URLLC, Massive Machine-Type Communications (mMTC) slice, Vehicle To Everything (V2X), Fixed Wireless Access (FWA), private, and the like. The network slices of communication network 100 may comprise portions of the user plane and control plane in core network 120, portions of access network 110, portions of IMS core 130, or may reside in other locations within communication network 100.

The computing systems of IMS core 130 store and execute multimedia functions to provide services like voice calling, video conferencing, and text messaging to user device 101. For example, IMS core 130 may receive text messages or voice call requests sent by user device 101 and route the text messages and voice call requests to their respective message destinations. In response to a registration request received from user device 101, CSCF 131 interfaces with control plane functions and NSSF 121 in core network 120 to determine user device 101's slice ID and to register user device 101 for multimedia services. CSCF 131 associates various network slice features with slice IDs received from NSSF 121. CSCF 131 hosts the data structure illustrated in FIG. 1. As illustrated in FIG. 1, slice ID A is associated with network slice feature A, slice ID B is associated with network slice features B, slice ID C is associated with network slice features C, and slice ID D is associated with network slice features D. By associating slice IDs with different slice features, communication network 100 may tailor IMS service for different groups of subscribers. For example, users that are subscribed for enhanced network slices may be associated with control plane encryption, user plane encryption, and priority voice/video calling while users that are subscribed for standard network slices may be associated with control plane encryption. IMS core 130 may store and execute other IMS functions like Telephony Application Server (TAS) and Short Message Service Application Server (SMS AS).

Data network 140 comprises application servers, gateways, routers, Content Distribution Networks (CNDs) and/or other communication devices to participate in data sessions with user device 101. For example, data network 140 may comprise an application server that hosts the server-side component of a user application executing on user device 101. Data network 140 may be representative of a public data network (e.g., the Internet) or a private data network (e.g., an enterprise network). Core network 120, IMS core, and data network 140 may communicate via links provided by internet backbone providers, edge computing services, and/or other communication services that provide the data links between core network 120, IMS core 130, and data network 140.

User device 101 and access network 110 comprise antennas, amplifiers, filters, modulation, analog/digital interfaces, microprocessors, software, memories, transceivers, bus circuitry, and the like. User device 101, access network 110, core network 120, IMS core 130, and data network 140 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of communication network 100 as described herein.

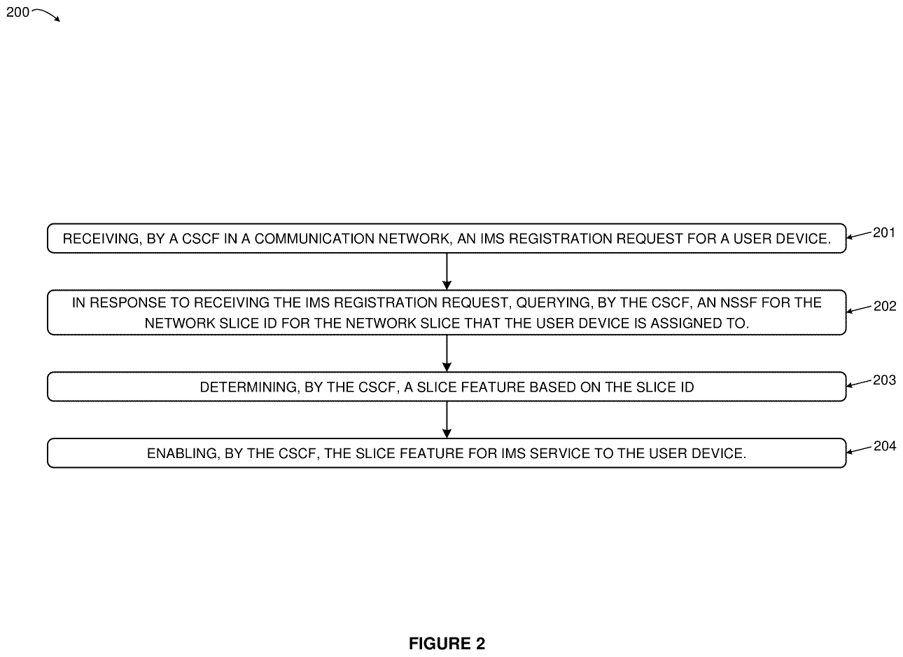

FIG. 2 illustrates process 200. Process 200 comprises an exemplary operation of communication network 100 to enable network slice features in IMS. Process 200 may vary in other examples. The operations of process 200 comprise receiving, by a CSCF in a communication network, an IMS registration request for a user device (step 201). The operations further comprise in response to receiving the IMS registration request, querying, by the CSCF, an NSSF for the network slice ID for the network slice that the user device is assigned to (step 202). The operations further comprise determining, by the CSCF, a slice feature based on the slice ID (step 203). The operations further comprise enabling, by the CSCF, the slice feature for the IMS service to the user device (step 204).

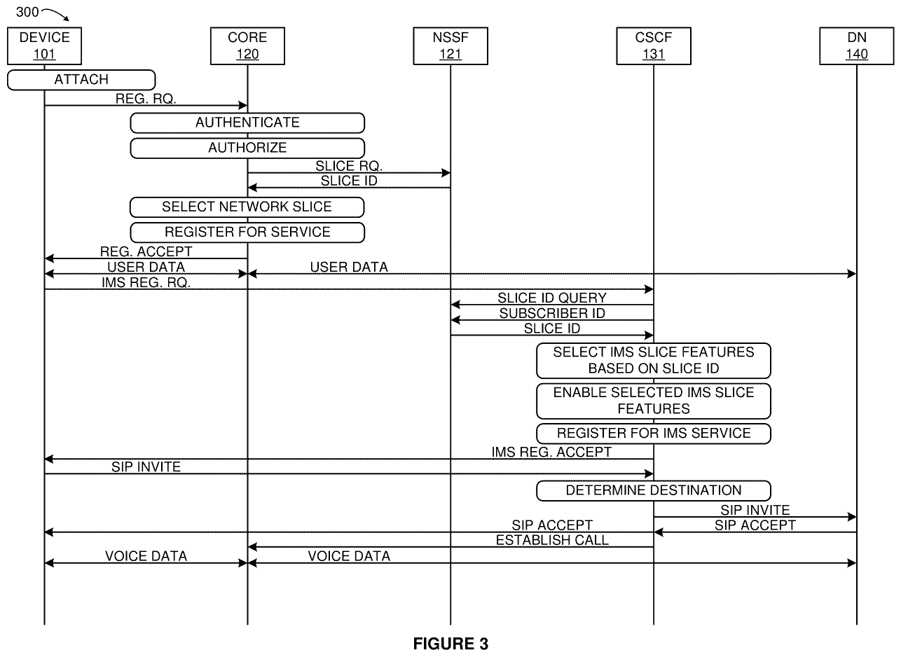

FIG. 3 illustrates process 300. Process 300 comprises an exemplary operation of communication network 100 to enable network slice features in IMS. Process 300 comprises an example of process 200 illustrated in FIG. 2, however process 200 may differ. Process 300 may vary in other examples. In some examples, user device 101 attaches to access network 110. User device 101 transfers a registration request (REG RQ) core network 120 over access network 110. The registration request includes information like subscriber Identifier (ID), device capabilities, Protocol Data Unit (PDU) session requests, slice requests, and the like. Core network 120 authenticates user device 101 and authorizes user device 101 for service on communication network 100. Core network 120 provides the slice request received in user device 101's registration request to NSSF 121. NSSF 121 maps the slice request to an allowed slice type and returns a slice ID for a network slice instance in communication network 100 that comprises the allowed slice type. For example, user device 101 may include a Single-Network Slice Selection Assistance Information (S-NSSAI) for a URLLC slice in the registration request. NSSF 121 may map the S-NSSAI for the URLLC slice to an allowed NSSAI for user device 101 and return a slice ID for a URLLC slice based on the mapping. Core network 120 selects a network slice for user device 101 based on the slice ID returned by NSSF 121.

Responsive to authentication and authorization, core network 120 registers user device 101 for service on communication network 100. Core network 120 transfers a registration (REG) accept message to user device 101. The registration accept message includes information like device context, network addresses, slice IDs, and/or other information for user device 101 to begin its data session. User device 101 begins a data session on communication network 100 based on the registration accept message. User device 101 exchanges user data with data network 140 over access network 110 and core network 120 using the network slice assigned to user device 101.

Subsequent to network registration, user device 101 transfers an IMS registration request to CSCF 131 over access network 110 and core network 120. The IMS registration request includes a subscriber ID like IMSI that identifies user device 101. In response to receiving the IMS registration request, CSCF 131 transfers a slice ID query to NSSF 121 over a 5GC SBI link between CSCF 131 and NSSF 121. The query includes the subscriber ID of user device 101. NSSF 121 correlates the subscriber ID included in the request to the slice ID of the network slice assigned to user device 101. NSSF 121 returns the slice ID to CSCF 131. CSCF 131 hosts a data structure that correlates slice IDs to network slice features. CSCF 131 inputs the slice ID into the data structure which outputs a set of slice features associated with the network slice for user device 101. CSCF 131 enables the slice features output by the data structure and registers user device 101 for IMS service. For example, the available slice features may comprise control plane encryption, user plane encryption, codec type restriction, priority service, and IMS function selection. The output from the data structure may select control plane encryption. In response, CSCF 131 may enable control plane encryption as a slice feature for user device 101. CSCF 131 transfers an IMS registration accept message to user device 101 over core network 120 and access network 110.

User device 101 receives the IMS registration accept message and responsively begins a voice calling session. For example, user device 101 may receive a user input to call another user device. User device 101 transfers a Session Initiation Protocol (SIP) invite to begin the voice calling session to CSCF 131 over access network 110 and core network 120. CSCF 131 determines the message destination for the SIP invite and routes the SIP invite to the destination. Subsequently, CSCF 131 receives a SIP accept message from the message destination. CSCF 131 forwards the SIP accept message to user device 101 and directs core network 120 to establish an end-to-end voice link between user device 101 and the message destination. User device 101 exchanges voice data with the message destination over core network 120 and data network 140 with the message destination. CSCF 131 and/or core network 120 apply the enabled slice features to user device 101's voice session.

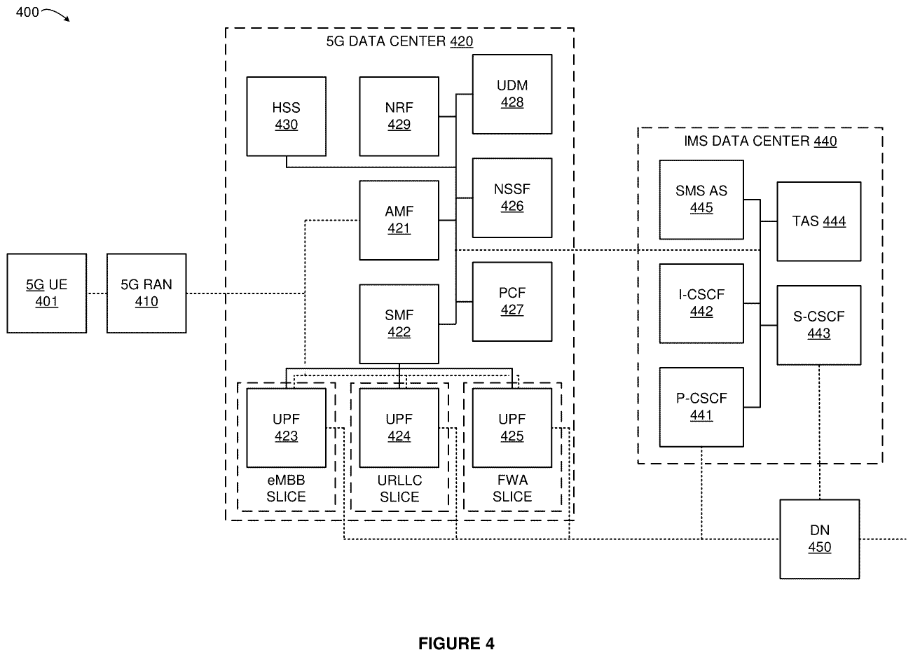

FIG. 4 illustrates 5G communication network 400 to enable network slice features in IMS. 5G communication network 400 comprises an example of communication network 100 illustrated in FIG. 1, however communication network 100 may differ. 5G communication network 400 comprises 5G UE 401, 5G RAN 410, 5G data center 420, IMS data center 440, and data network 450. 5G data center 420 comprises AMF 421, SMF 422, UPFs 423-425, NSSF 426, PCF 427, UDM 428, NRF 429, and HSS 430. Other network functions and network entities like Authentication Server Function (AUSF), Charging Function (CHF), Home Subscriber Register (HLR), Unified Data Registry (UDR), Short Message Service Function (SMSF), Network Exposure Function (NEF), Application Function (AF), Equipment Identity Register (EIR), and Session Communication Proxy (SCP) are typically present in 5G data center 420 but are omitted for clarity. IMS data center 440 comprises Proxy-Call Session Control Function (P-CSCF) 441, Interrogating-Call Session Control Function (I-CSCF) 442, Serving-Call Session Control Function (S-CSCF) 443, TAS 444, and SMS AS 445. 5G data center 420 comprises an eMBB slice, a URLLC slice, and an FWA slice. UPF 423 forms the eMBB slice, UPF 424 forms the URLLC slice, and UPF 425 forms the FWA slice. Although illustrated as only comprising UPFs, the eMBB slice, URLLC slice, and FWA slice may comprise other network elements in 5G communication network 400. Moreover, some elements may be shared between different ones of the network slices. For example, the eMBB slice and the URLLC slice may both comprise SMF 422. It should be appreciated that 5G communication network 400 typically comprises many more network slices and slice types (e.g., V2X slices, mMTC slices, private slices, etc.) and that three distinct slices are shown for clarity. In other examples, 5G communication network 400 may comprise different or additional elements than those illustrated in FIG. 4.

In some examples, 5G UE 401 attaches to 5G RAN 410. UE 401 transfers a registration request to AMF 421 over 5G RAN 410. The registration request indicates NSSAI requests as well as a registration type, 5G-Global Unique Temporary Identifier (GUTI), Tracking Area Identifier (TAI), UE capabilities, PDU session requests, and the like. In response to the registration request, AMF 421 transfers a Non-Access Stratum (NAS) identity request to UE 401 over 5G RAN 410 and the radio signaling bearer. UE 401 indicates its Subscriber Concealed Identifier (SUCI) to AMF 421 over 5G RAN 410. AMF 421 interfaces with other network functions like UDM 428 to derive the Subscriber Permanent Identifier (SUPI) of UE 401 and to authenticate the identity of UE 401. Typically, authentication involves presenting a random number challenge to UE 401 and matching an authentication response from UE 401 with an expected result to verify the identity of UE 401.

Responsive to the authentication, AMF 421 interfaces with UDM 428 to generate context for UE 401. The UE context defines the authorized services for UE 401. To form the context, AMF 421 retrieves access and mobility subscription data, SMF selection subscription data, and UE context in SMF data from UDM 428. The access and mobility subscription data comprises a supported feature list for UE 401 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of allowed S-NSSAIs and associated information. The UE context in SMF data comprises PDU session and EPC interworking information. AMF 421 forms the UE context for UE 401 using the retrieved information. AMF 421 interfaces with PCF 427 to retrieve policy association information for UE 401. The policy association information comprises the SUPI, GPSI, PEI, and user location information for UE 401.

AMF 421 selects NSSF 426 to select a network slice for UE 401. AMF 421 may utilize NRF 429 to locate NSSF 426 in 5G data center 420 (e.g., by transferring an NSSF discovery request to NRF 429). AMF 421 transfers a slice selection request for UE 401 to NSSF 426. The slice selection request includes the requested NSSAIs received in UE 401 registration request, the SUPI of UE 401, as well as other data like Tracking Area Identifier (TAI), Public Land Mobility Network (PLMN) ID, and the like. NSSF 426 maps the requested NSSAIs to allowed NSSAIs. NSSF 426 may determine allowed NSSAIs based on factors like availability, slice loading, provisioning information, and the like. NSSF 426 selects one or more of the network slices available in 5G data center 420 based on the mapping and provides the S-NSSAIs for the selected network slice(s) to AMF 421. AMF 421 assigns UE 401 to the network slice(s) based on the response from NSSF 426. For example, if NSSF 426 generates a response that selects the eMBB slice for UE 401, AMF 421 may assign UE 401 to the eMBB slice.

AMF 421 selects SMF 422 to serve UE 401 based on SMF selection data, the policy association information, and/or the network slice(s) of UE 401. AMF 421 transfers a list of requested PDU sessions (as received during the registration request), a PDU session activation command, the SUPI, and typically other information associated with UE 401 to SMF 422. SMF 422 receives the PDU session list, session activation command, and the SUPI from AMF 421. SMF 422 allocates an IP address to UE 401 for the requested PDU session and allocates a Tunnel Endpoint Identifier (TEID) for the session. SMF 422 selects one or more of UPFs 423-425 to serve UE 401 based on UE 401's network slice(s). SMF 422 transfers a session modification request that includes a session endpoint identifier and TEID to the selected one(s) of UPFs 423-425 to set up the PDU session for UE 401. The selected one(s) of UPFs 423-425 sets up a default bearer for UE 401 with 5G RAN 410. The default bearer is a link to carry IP packets for UE 401's PDU session. The selected one(s) of UPFs 423-425 transfers a session modification response to SMF 422 that includes the session endpoint identifier to confirm bearer setup. SMF 422 discovers P-CSCF 441 and selects P-CSCF 441 for UE 401 to perform IMS registration.

SMF 422 returns a PDU session create response to AMF 421 to confirm session creation. The response includes the updated session context (e.g., allocated IP addresses, TEID, P-CSCF address, etc.). In response, AMF 421 registers UE 401 for service on 5G data center 420. AMF 421 generates a registration accept message that includes the allocated UE IP address, RAN ID, AMBR, Globally Unique AMF ID (GUAMI), PDU session ID, PDU session TEID, allowed NSSAI list, security data, P-CSCF address, and the like. AMF 421 transfers the registration accept message to 5G RAN 410 to direct 5G RAN 410 to serve UE 401. 5G RAN 410 transfers an RRC reconfiguration message to UE 401 to set up data radio bearers. The message includes cell IDs, bearer configuration information, network address (e.g., the address for P-CSCF 441), and the like. UE 401 configures its radio bearers using the received information. In response, UE 401 begins its PDU session on 5G communication network 400. 5G RAN 410 wirelessly exchanges user data for the PDU session with UE 401. 5G RAN 410 exchanges the user data with one(s) of UPFs 423-425 that correspond to UE 401's network slice(s). The one(s) of UPFs 423-425 exchanges the user data with data network 450.

In response to successful network registration, UE 401 initiates an IMS registration request to register with IMS data center 440. UE 401 generates an IMS registration request and uses the network address P-CSCF 441 received in the RRC reconfiguration message to transfer the registration message to RAN 410. The IMS registration request indicates the SUCI of UE 401 or another type of subscriber ID. RAN 410 transfers the IMS registration request to P-CSCF 441 over one of UPFs 423-425.

P-CSCF 441 receives the IMS registration request for UE 401. In response to the registration request and prior to continuing the IMS registration procedure, P-CSCF 441 determines the network slice(s) that UE 401 is assigned to. P-CSCF 441 extracts UE 401's SUCI from the registration request. P-CSCF 441 transfers a slice information request to NSSF 426 that includes UE 401's SUCI to determine UE 401's slices over a 5GC SBI link between P-CSCF 441 and NSSF 426. In examples where P-CSCF 441 is unaware of NSSF 426, P-CSCF 441 may transfer an NSSF discovery request to NRF 429 and NRF 429 may return a NSSF ID for NSSF 426 to P-CSCF 441. P-CSCF 441 may then transfer the slice discovery request to NSSF 426 based on the NSSF ID returned by NRF 429. Returning to the operation, NSSF 426 receives the slice discovery request from P-CSCF 441. NSSF 426 derives the SUPI of UE 401 based on the SUCI included in the request. For example, NSSF 426 may interface with UDM 428 to derive the SUPI of UE 401 based on the SUCI included in the IMS registration request. NSSF 426 determines the S-NSSAI(s) of the network slice(s) UE 401 is assigned to based on the SUPI. NSSF 426 provides the S-NSSAI(s) of UE 401's network slice(s) to P-CSCF 441.

P-CSCF 441 determines one or more network slice features to enable for UE 401's IMS service based on the S-NSSAI(s) received from NSSF 426. For example, P-CSCF 441 may host a data structure that correlates different S-NSSAIs to different network slice features. Exemplary network slice features include control plane signaling encryption, user plane data encryption, codec type restriction, S-CSCF selection criteria, priority voice/video calling service, and/or other network slice features. P-CSCF 441 enables the one or more network slice features to complete the registration process and/or to provide IMS service to UE 401.

Depending on the network slice feature types, P-CSCF 441 may indicate the network slice features to PCF 427, I-CSCF 442, S-CSCF 443, and/or other IMS functions and 5GC network functions to enable the network slice features. For example, if the enabled network slice feature comprises user plane voice/video data encryption, P-CSCF 441 may interface with PCF 427 to enforce user plane voice/video data encryption on ones of UPFs 423-425. For example, if the enabled network slice feature comprises S-CSCF selection criteria, P-CSCF 441 may interface with I-CSCF 442 to select an S-CSCF based on the S-CSCF selection criteria (e.g., to assign UE 401 to a S-CSCF reserved for specific subscribers). In some examples, P-CSCF 441 may not have to interface with other 5GC or IMS functions to enable the network slice features. For example, if the enabled network slice feature comprises control plane encryption between UE 401 and P-CSCF 441, P-CSCF 441 may select a control plane encryption protocol like Internet Protocol Security (IPsec) or Transport Layer Security (TLS) and use the control plane encryption protocol for future control plane communications with UE 401. For example, if the enabled network slice feature comprises user plane encryption, P-CSCF 431 may select a user plane encryption protocol like Secure Real-Time Transport Protocol (SRTP) and UE 401 may use the user plane encryption protocol for future user plane data exchange (e.g., voice data exchanged during a voice call). P-CSCF 441 may indicate the encryption protocol(s) to UE 401 in a future registration message. For example, P-CSCF 441 may modify the message header of the SIP 401 message to indicate the encryption protocol(s).

Once the network slice features are enabled, P-CSCF 441 continues the IMS registration process. P-CSCF 441 retrieves a network address for I-CSCF 442 (e.g., by DNS query) and forwards the registration request to I-CSCF 442 using the retrieved network address. I-CSCF 442 generates a User Authorization Request (UAR) to identify available S-CSCFs and transfers the UAR for delivery to HSS 430. HSS 430 determines a set of available S-CSCFs, including S-CSCF 443, and transfers a User Authorization Answer (UAA) indicating the S-CSCFs. I-CSCF 442 receives the UAA and selects S-CSCF 443 to register UE 401 for IMS services. I-CSCF 442 forwards the registration request to S-CSCF 443.

S-CSCF 443 receives the registration request and generates a Multimedia Authentication Request (MAR) to retrieve user authentication data associated with UE 401. S-CSCF 443 transfers the MAR for delivery to HSS 430. HSS 430 receives the MAR and accesses a subscriber profile for UE 401 to retrieve authentication data. The authentication data typically includes a random number, an authentication token, a signed result, a cipher key, and an integrity key. HSS 430 transfers a Multimedia Authentication Answer (MAA) that includes the authentication data to S-CSCF 443.

S-CSCF 443 selects authentication vectors to verify the identity of UE 401 based on the authentication data. S-CSCF 443 generates a SIP 401 message that comprises the authentication data. S-CSCF 443 transfers the SIP 401 message to I-CSCF 442 which in turn forwards the SIP 401 message to P-CSCF 441. P-CSCF 441 removes and caches a portion of the authentication data from the SIP 401 message. The remaining authentication data in the SIP 401 message comprises a random number and authentication token that UE 401 can use to generate an authentication response to verify its identity. P-CSCF 441 transfers the SIP 401 message to UE 401 over one of UPFs 423-425 and RAN 410. For example, when the network slice feature comprises control plane encryption, P-CSCF 441 may indicate the encryption protocol in the header of the SIP 401 message to establish a secure tunnel between P-CSCF 441 and UE 401 for future control plane communications. UE 401 uses the random number received in the SIP 401 message to generate an authentication response. For example, UE 401 may hash the random number using its secret identity code to generate the authentication response.

UE 401 generates a second IMS registration request to complete the registration with IMS data center 440. UE 401 addresses the second request for P-CSCF 441 and transfers the second request to P-CSCF 441 over RAN 410 and one of UPFs 423-425. P-CSCF 441 forwards the request to I-CSCF 442. I-CSCF 442 generates a second UAR and transfers the second UAR to HSS 430. HSS 430 receives the second UAR and determines a set of S-CSCFs and transfers a second UAA indicating the S-CSCFs to I-CSCF 442. I-CSCF 442 selects S-CSCF 443 based on the second UAA and forwards the second registration request to S-CSCF 443. S-CSCF 443 receives the second registration request and generates a Server Assignment Request (SAR) to retrieve subscriber data associated with UE 401 to verify the authentication response generated by UE 401. S-CSCF 443 transfers the SAR for delivery to HSS 430. HSS 430 receives the SAR and accesses a subscriber profile for UE 401 to retrieve the subscriber data. HSS 430 transfers a Server Assignment Answer (SAA) that includes the subscriber data to S-CSCF 443. S-CSCF 443 matches an expected result for the authentication challenge to the authentication response from UE 401 to authenticate the identity of UE 401. S-CSCF 443 registers UE 401 for IMS service based on the authentication. S-CSCF 443 generates a SIP 200 message to acknowledge the registration. S-CSCF 443 transfers the SIP 200 message to I-CSCF 442 which in turn forwards the SIP 200 message to P-CSCF 441. P-CSCF 441 transfers the SIP 200 message to UE 401 over one of UPFs 423-425 and RAN 410.

Once registered, UE 401 initiates a Mobile Originated (MO) IMS voice session (or some other type of IMS media session) with IMS data center 440. UE 401 generates a SIP invite message and addresses the message for delivery to P-CSCF 441. UE 401 transfers the SIP invite to RAN 410. RAN 410 transfers the SIP invite to P-CSCF 441 over one of UPFs 423-425. P-CSCF 441 interfaces with I-CSCF 442 and S-CSCF 443 to deliver the SIP invite to a Mobile Terminal (MT) UE (i.e., called UE). S-CSCF 443 processes the SIP invite to select a message destination to set up the MO IMS session. S-CSCF 443 transfers the SIP invite to an application server in data network 450 which routes the SIP invite to the MT UE. The MT UE accepts the call and S-CSCF 443 indicates the acceptance to UE 401 over P-CSCF 441, one of UPFs 423-425, and RAN 410. UE 401 exchanges user data for the MO IMS voice session with one of UPFs 423-425 over RAN 410. The one or UPFs 423-425 exchanges the user data for the MO IMS voice session with the application server in data network 450 which exchanges the user data with the called UE. PCF 427, P-CSCF 441, I-CSCF 442, S-CSCF 443, TAS 444, and SMS AS 445 operate to monitor the MO IMS voice session, control the data flow for UE 401, and apply the enabled network slice features for UE 401's IMS session.

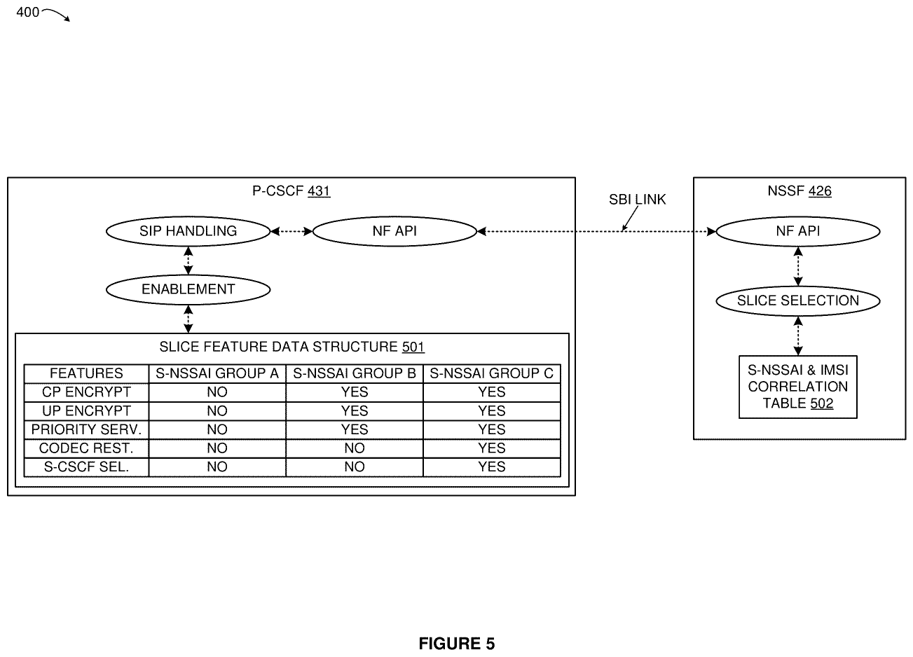

FIG. 5 illustrates P-CSCF 441 and NSSF 426 in 5G communication network 400. In some examples, NSSF 426 comprises modules for network function Application Programming Interface (API), slice selection, and stores S-NSSAI and IMSI correlation table 502. The slice selection module maps requested S-NSSAIs to allowed S-NSSAIs, selects network slice instances based on the mapping, and returns IDs for the selected network slices to requesting entities. The S-NSSAI and IMSI correlation table 502 associates IMSIs for UEs in 5G communication network 400 to the S-NSSAIs of the network slices that the UEs are assigned to. P-CSCF 441 comprises modules for network function API, SIP message handling, slice feature enablement, and stores slice feature data structure 501. The SIP message handling module processes incoming SIP messages and routes the messages to their intended destinations. The slice feature enablement module interfaces with NSSF 426 to determine S-NSSAIs for UEs in response to receiving registration requests from the UEs. The enablement module enables network slice features for IMS service based on output from slice feature data structure 501. The network function APIs allow P-CSCF 441 and NSSF 426 to communicate with each other and with other network functions and IMS functions in 5G data center 420 and IMS data center 440.

Slice feature data structure 501 associates network slice features with S-NSSAI groups. In this example, the network slice features comprise control plane (CP) encryption (e.g., IPsec, TLS, etc.), user plane (UP) encryption, priority service (SERV.), codec type restriction (REST.), and S-CSCF selection (SEL.), however in other examples, the network slice feature may differ. As illustrated in FIG. 5, none of the slice features are enabled for S-NSSAI group A, control plane encryption, user plane encryption, and priority service are enabled for S-NSSAI group B, and all of the slice features are enabled for S-NSSAI group C. Typically, the number of slice features enabled for a network slice corresponds to the quality, importance, capabilities, and/or price of the slice. For example, S-NSSAI group A may comprise a set of default or best effort network slices, S-NSSAI group B may comprise a set of mid-tier network slices, and S-NSSAI group C may comprise a set of premium network slices. The enablement module provides an S-NSSAI to slice feature data structure 501. Slice feature data structure 501 maps the S-NSSAI to one of S-NSSAI groups A-C, and indicates the enabled slice features for that S-NSSAI group to the enablement module.

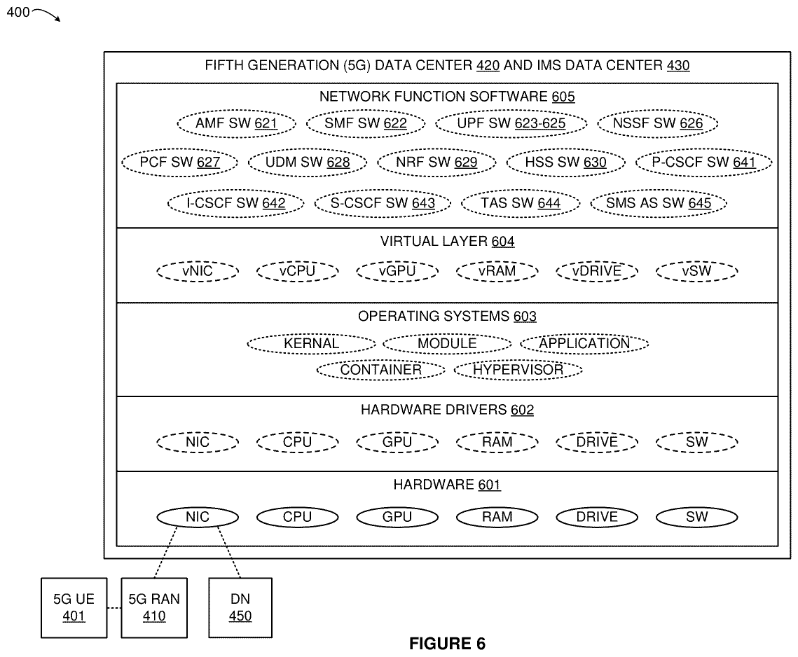

FIG. 6 illustrates 5G data center 420 and IMS data center 440 in 5G communication network 400. 5G data center 420 comprises an example of core network 120 illustrated in FIG. 1, although core network 120 may differ. IMS data center 440 comprises an example of IMS core 130 illustrated in FIG. 1, although IMS core 130 may differ. 5G data center 420 and IMS data center 440 typically comprise a virtualized computing architecture like NFVI, but may comprise another computing architecture like a cloud computing network, a hybrid cloud network, and the like. 5G data center 420 and IMS data center 440 comprise hardware 601, hardware drivers 602, operating systems 603, virtual layer 604, and network function software 605. Hardware 601 comprises Network Interface Cards (NICs), CPU, GPU, RAM, Flash/Disk Drives (DRIVE), and Data Switches (SW). Hardware drivers 602 comprise software that is resident in the NIC, CPU, GPU, RAM, DRIVE, and SW. Operating systems 603 comprise kernels, modules, applications, containers, hypervisors, and the like. Virtual layer 604 comprises vNIC, vCPU, vGPU, vRAM, vDRIVE, and vSW. Network function software 605 comprises AMF Software (SW) 621, SMF SW 622, UPF SW 623-625, NSSF SW 626, PCF SW 627, UDM SW 628, NRF SW 629, HSS SW 630, P-CSCF SW 641, I-CSCF SW 642, S-CSCF SW 643, TAS SW 644, and SMS AS SW 645. Additional network function software for network functions like AUSF, UDR, CHF, HLR, NRF, SMSF, NEF, AF, EIR, and SCP is typically present but is omitted for clarity. 5G data center 420 and IMS data center 440 may be located at a single site or be distributed across multiple geographic locations. For example, 5G data center 420 may be located at a first geographic location while IMS data center 440 may be located at a second geographic location. The NIC in hardware 601 is coupled to 5G RAN 410, data network (DN) 450, and to external systems (not illustrated). Hardware 601 executes hardware drivers 602, operating systems 603, virtual layer 604, and network function software 605 to form AMF 421, SMF 422, UPFs 423-425, NSSF 426, PCF 427, UDM 428, NRF 429, HSS 430, P-CSCF 441, I-CSCF 442, S-CSCF 443, TAS 444, and SMS AS 445.

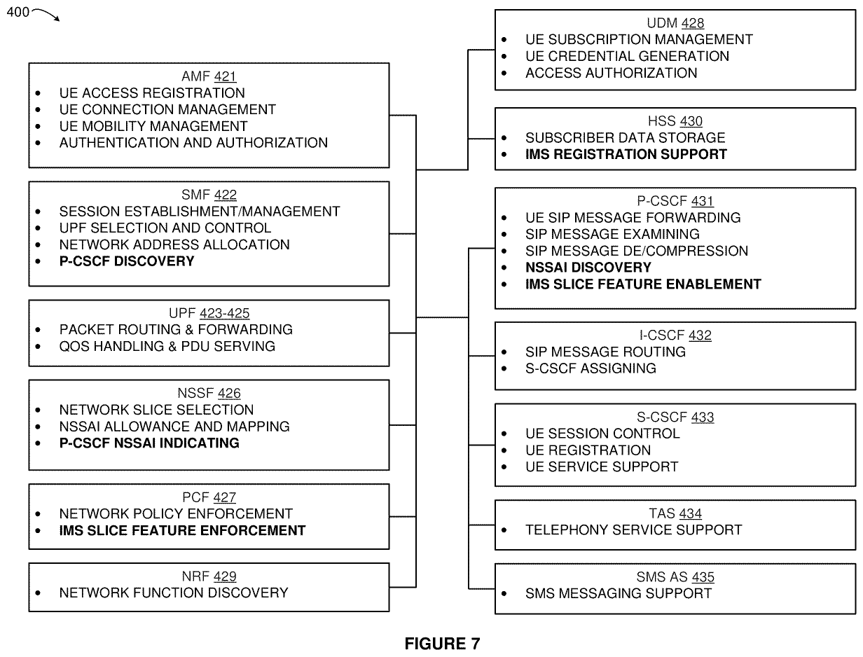

FIG. 7 further illustrates 5G data center 420 and IMS data center 440 in 5G communication network 400. AMF 421 capabilities comprise UE access registration, UE connection management, UE mobility management, UE authentication, UE authorization, and virtual slice request management. SMF 422 capabilities comprise session establishment, session management, UPF selection, UPF control, network address allocation, and P-CSCF discovery. UPFs 423-425 capabilities comprise for packet routing, packet forwarding, QoS handling, and PDU serving. NSSF 426 comprises capabilities for network slice selection, NSSAI allowance, NSSAI mapping, and P-CSCF NSSAI indicating. PCF 427 comprises capabilities for network policy enforcement and IMS slice feature enforcement. UDM 428 comprises capabilities for UE subscription management, UE credential generation, and access authorization. NRF 429 comprises capabilities for network function discovery. HSS 430 comprises capabilities for subscriber data storage and IMS registration support. P-CSCF 441 comprises capabilities for UE SIP message forwarding, SIP message examining, SIP message compression and decompression, NSSAI discovery, and IMS slice feature enablement. I-CSCF 442 comprises capabilities for SIP message routing and S-CSCF assigning. S-CSCF 443 comprises capabilities for UE session control, UE registration, and UE service support. TAS 444 comprises capabilities for telephony service support. SMS AS 445 comprises capabilities for SMS message support.

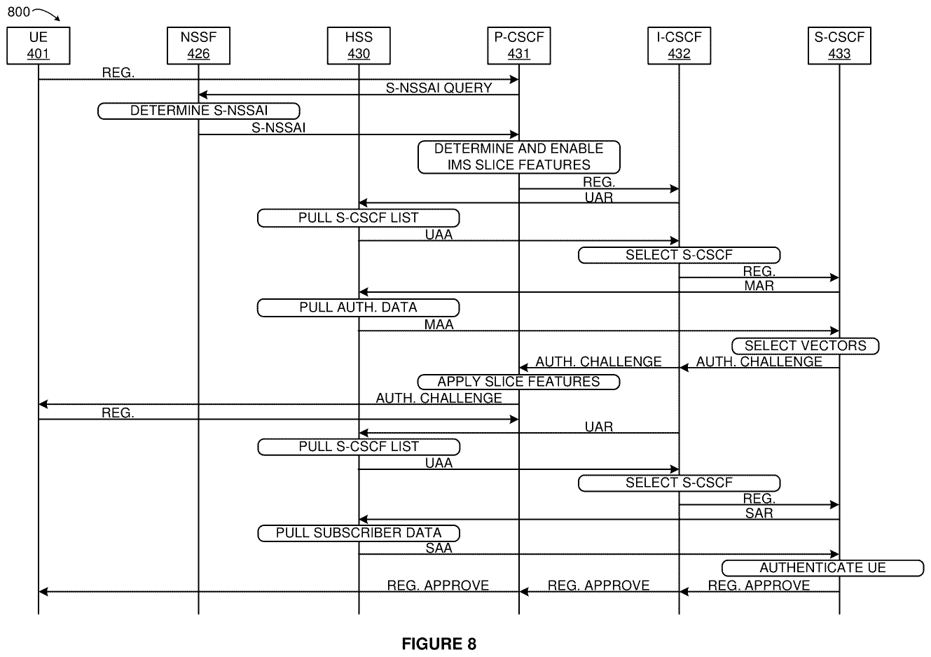

FIG. 8 illustrates process 800. Process 800 comprises an exemplary operation of 5G communication network 400 to enable network slice features in IMS. Process 800 comprises an example of processes 200 and 300 illustrated in FIGS. 2 and 3, however processes 200 and 300 may differ. Process 800 may differ in other examples. In some examples, UE 401 transfers an IMS registration request to P-CSCF 441 in response to successful network registration. P-CSCF 441 transfers an S-NSSAI query that includes UE 401's SUCI to NSSF 426. NSSF 426 derives the SUPI of UE 401 based on the SUCI included in the request. For example, NSSF 426 may interface with UDM 428 to recover the SUPI from the SUCI. It should be appreciated that the SUPI comprises UE 401's IMSI. NSSF 426 compares UE 401's IMSI to S-NSSAI and IMSI correlation table 502 to determine the S-NSSAI(s) of the network slices assigned to UE 401. In this example, UE 401 is assigned to the URLLC slice in 5G data center 420. NSSF 426 identifies the S-NSSAI for the URLLC slice based on the comparison and returns the S-NSSAI to P-CSCF 441.

P-CSCF 441 enters the S-NSSAI for the URLLC slice into slice feature data structure 501. Slice feature data structure 501 determines the S-NSSAI for the URLLC slice is within S-NSSAI group B (as depicted in FIG. 5) and provides an output to P-CSCF 441 that indicates slice features for control plane encryption, user plane encryption, and priority voice/video calling. It should be appreciated that the slice features for S-CSCF selection and codec type restriction are not enabled based on UE 401's slice feature falling into S-NSSAI group B. In response, P-CSCF 441 enables control plane encryption, user plane encryption, and priority voice/video calling for UE 401. P-CSCF 441 selects TLS as the encryption protocol for control plane encryption between P-CSCF 441 and UE 401 and selects a user plane encryption protocol (e.g., SRTP) for UE 401's voice/video sessions. P-CSCF 441 instructs PCF 427 to enforce user plane encryption for UE 401's IMS sessions. P-CSCF 441 instructs S-CSCF 443 to provide priority voice/video calling service for UE 401. In other examples, P-CSCF 441 may select a different control plane encryption protocol like IPsec.

P-CSCF 441 performs a DNS query to retrieve a network address for I-CSCF 442 and forwards the IMS registration request to I-CSCF 442. I-CSCF 442 transfers a UAR to select a S-CSCF for delivery to HSS 430. HSS 430 determines a set of available S-CSCFs in response to the UAR and transfers a UAA indicating the S-CSCFs to I-CSCF 432. I-CSCF 442 receives the UAA and selects S-CSCF 443 to register UE 401 for IMS services. I-CSCF 442 forwards the IMS registration request to S-CSCF 443. S-CSCF 443 transfers a MAR to HSS 430 to retrieve user authentication data associated with UE 401. HSS 430 retrieves authentication data from UE 401's subscriber profile. HSS 430 transfers an MAA that includes the authentication data to S-CSCF 443.

S-CSCF 443 selects authentication vectors to verify the identity of UE 401 based on the authentication data. S-CSCF 443 generates a SIP 401 message that comprises the authentication data. S-CSCF 443 transfers the SIP 401 message to I-CSCF 442 which in turn forwards the SIP 401 message to P-CSCF 441. P-CSCF 441 removes and caches a portion of the authentication data from the SIP 401 message. The remaining authentication data in the SIP 401 message comprises a random number and authentication token that UE 401 can use to generate an authentication response to verify its identity. P-CSCF 441 modifies the header of the SIP 401 message to indicate TLS as the selected control plane encryption protocol to enable the control plane encryption slice feature. P-CSCF 441 transfers the SIP 401 message to UE 401 over one(s) over UPFs 423-425 and RAN 410. UE 401 and P-CSCF 441 establish an end-to-end encrypted tunnel using TLS as the encryption protocol. UE 401 uses the random number received in the SIP 401 message to generate an authentication response. In examples where IPsec is the selected control plane encryption protocol, P-CSCF 441 may modify the SIP message header to indicate IPsec as the selected control plane encryption protocol and UE 401 and P-CSCF 441 may establish the end-to-end encrypted tunnel using IPsec as the control plane encryption protocol.

UE 401 generates a second IMS registration request to complete the registration with IMS data center 440. UE 401 transfers the second IMS request to P-CSCF 441 over RAN 410 and UPF 424 in the end-to-end encrypted tunnel. P-CSCF 441 forwards the request to I-CSCF 442. I-CSCF 442 transfers a second UAR to HSS 430. HSS 430 determines a set of S-CSCFs and transfers a second UAA indicating the S-CSCFs to I-CSCF 442. I-CSCF 442 selects S-CSCF 443 based on the second UAA and forwards the second registration request to S-CSCF 443.

S-CSCF 443 transfers a SAR to HSS 430 to retrieve subscriber data associated with UE 401 to verify the authentication response generated by UE 401. HSS 430 retrieves subscriber data from the subscriber profile for UE 401. HSS 430 transfers a SAA that includes the subscriber data to S-CSCF 443. S-CSCF 443 matches an expected result for the authentication challenge to the authentication response from UE 401 to authenticate the identity of UE 401. S-CSCF 443 registers UE 401 for IMS service based on the authentication. S-CSCF 443 generates a SIP 200 message to acknowledge the registration. S-CSCF 443 transfers the SIP 200 message to I-CSCF 442 which in turn forwards the SIP 200 message to P-CSCF 441. P-CSCF 441 transfers the SIP 200 message to UE 401 over UPF 424 and RAN 410 in the end-to-end encrypted tunnel.

UE 401 receives a user input initiating a voice call with another UE. UE 401 transfers a SIP invite that identifies the phone number of the called UE to P-CSCF 441 over RAN 410 and UPF 424 in the end-to-end encrypted tunnel. P-CSCF 441 provides the SIP invite to S-CSCF 443. S-CSCF 443 prioritizes establishing the voice session for UE 401 over lower priority UEs based on the enabled priority voice/video calling slice feature for UE 401. S-CSCF 443 processes the SIP invite to determine the message destination. S-CSCF 443 routes the SIP invite to the called UE over data network 450. The called UE accepts the call. S-CSCF 443 receives a SIP accept message transferred by the called UE over data network 450 and indicates the acceptance to UE 401. UE 401 begins the voice call in response to the accept message. UE 401 exchanges voice data with UPF 424 over RAN 410. UPF 424 exchanges the user data with data network 450 which exchanges the user data with the called UE. PCF 427 enforces user plane encryption on the voice data exchange over 5G communication network 400 based on the enabled user plane encryption slice feature. For example, PCF 427 may interface with SMF 422 to set up an encrypted voice tunnel that traverses RAN 410, UPF 424, and data network 450.

The wireless data network circuitry described above comprises computer hardware and software that form special-purpose network circuitry to enable network slice features in IMS. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to enable network slice features in IMS.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
receiving, by a Call Session Control Function (CSCF) in a communication network, an Internet Protocol Multimedia Subsystem (IMS) registration request for a user device;
in response to receiving the IMS registration request, querying, by the CSCF, a Network Slice Selection Function (NSSF) for a network slice Identifier (ID) for a network slice that the user device is assigned to;
determining, by the CSCF, a slice feature based on the slice ID; and
enabling, by the CSCF, the slice feature for IMS service to the user device.

2. The method of claim 1 further comprising:
querying, by the CSCF, a Network Repository Function (NRF) to determine an NSSF ID; and wherein:
querying, by the CSCF, the NSSF for the network slice ID for the network slice that the user device is assigned to comprises querying, by the CSCF, the NSSF for the network slice ID for the network slice that the user device is assigned to based on the NSSF ID in response to receiving the IMS registration request.

3. The method of claim 1 further comprising:
hosting, by the CSCF, a data structure that correlates network slice IDs for network slices in the communication network to network slice features; and wherein:
determining, by the CSCF, a slice feature based on the slice ID comprising inputting the slice ID into the data structure and obtaining an output from the data structure that comprises the slice ID.

4. The method of claim 1 wherein the slice feature comprises control plane communication encryption between the CSCF and the user device.

5. The method of claim 1 wherein the slice feature comprises user plane communication encryption for a multimedia session of the user device.

6. The method of claim 1 wherein the slice feature comprises a priority service for a multimedia session of the user device.

7. The method of claim 1 wherein the slice feature comprises a codec type restriction for a multimedia session of the user device.

8. The method of claim 1 wherein the slice feature comprises a selection of a preferred IMS function.

9. The method of claim 1 wherein:
the CSCF comprises a Proxy-CSCF (P-CSCF); and wherein:
enabling, by the CSCF, the slice feature for IMS service to the user device comprises interfacing, by the P-CSCF, with at least one of an Interrogating-CSCF (I-CSCF) or a Serving-CSCF (S-CSCF) to enable the slice feature.

10. The method of claim 1 wherein enabling, by the CSCF, the slice feature for IMS service to the user device comprises interfacing, by the CSCF, with a Policy Control Function (PCF) to enable the slice feature.

11. The method of claim 1 wherein the network slice that the user device is assigned to comprises an Ultra-Reliable Low-Latency Communications (URLLC) slice.

12. The method of claim 1 wherein the network slice that the user device is assigned to comprises an Enhance Mobile Broadband (eMBB) slice.

13. The method of claim 1 wherein the network slice that the user device is assigned to comprises a Massive Machine Type Communications (mMTC) slice.

14. The method of claim 1 wherein the network slice that the user device is assigned to comprises a Fixed Wireless Access (FWA) slice.

15. The method of claim 1 wherein the network slice that the user device is assigned to comprises a Vehicle-to-Everything (V2X) slice.

16. The method of claim 1 wherein the network slice that the user device is assigned to comprises a private network slice.

17. A system comprising:
Call Session Control Function (CSCF) circuitry in a communication network configured to:
receive an Internet Protocol Multimedia Subsystem (IMS) registration request for a user device;
query a Network Slice Selection Function (NSSF) for a network slice Identifier (ID) for a network slice that the user device is assigned to in response to reception of the IMS registration request;
determine a slice feature based on the slice ID; and
enable the slice feature for IMS service to the user device.

18. The system of claim 17 wherein the CSCF circuitry is further configured to:
query a Network Repository Function (NRF) to determine an NSSF ID; and
query the NSSF for the network slice ID for the network slice that the user device is assigned to based on the NSSF ID in response to the reception of the IMS registration request.

19. The system of claim 17 wherein the CSCF circuitry is further configured to:
host a data structure that correlates network slice IDs for network slices in the communication network to network slice features;
input the slice ID into the data structure; and
obtain an output from the data structure that comprises the slice ID.

20. One or more non-transitory computer readable storage media having program instructions stored thereon, wherein the program instruction, when executed by a computing system, direct the computing system to perform operations, the operations comprising:
receiving an Internet Protocol Multimedia Subsystem (IMS) registration request for a user device in a communication network;
in response to receiving the IMS registration request, querying a Network Slice Selection Function (NSSF) for a network slice Identifier (ID) for a network slice that the user device is assigned to;
determining a slice feature based on the slice ID; and
enabling the slice feature for IMS service to the user device.
